(19) United States
(12) Patent Application Publication
(10) Pub. No.: US 2009/0083074 A1
(43) Pub. Date: Mar. 26, 2009

(54) MEDICAL REPORT MAKING SYSTEM, AND MEDICAL REPORT MAKING APPARATUS AND METHOD

(75) Inventor: Yoshifumi Shioe, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/212,275

(22) Filed: Sep. 17, 2008

(30) Foreign Application Priority Data
Sep. 21, 2007 (JP) 2007-245289

(51) Int. Cl. G06Q 50/00

(52) U.S. Cl. 705/3; 705/2

(57) ABSTRACT

A doctor interprets medical images taken through a medical inspection of a patient, and makes an image interpretation report on an image interpretation report making terminal, showing a result of the image interpretation. At that time, the doctor sets the degree of importance of the result of the image interpretation in the report. Based on the degree of importance set in the report, a CPU of the image interpretation report making terminal judges whether an urgent countermeasure is necessary for the patient or not. When the CPU judges that the urgent countermeasure is necessary, it produces a message based on the content written in the image interpretation report, and sends the message to a PHS terminal of a doctor who requested for the medical inspection. The CPU repeats sending the message until it receives a notice of opening the message from the doctor who requested for the medical inspection.

### FIELD OF THE INVENTION

The present invention relates to a medical report making system and a medical report making apparatus for making a medical report that reports a result of a medical inspection. The present invention relates also to a medical report making method for these system and apparatus.

### BACKGROUND OF THE INVENTION

In medical facilities like hospitals, a variety of medical examination apparatuses, such as modalities for CR (computed radiography), CT (computer tomography), MRI (magnetic resonation imaging), PET (positron emission tomography) and ultrasonic diagnosis, have been widely used. Medical images taken by the modalities are used in medical diagnoses, taking an important roll on determining the nature of a condition of a patient.

For the diagnosis based on medical images, doctors of individual diagnosis and treatment departments generally ask a doctor in an inspection department, like a radiologist, for an interpretation of the medical images. In the inspection department, the doctor interprets the medical images and reports the interpretation. Then, the doctor in the diagnosis and treatment department examines the report on the image interpretation, hereinafter referred to as the image interpretation report, to diagnose a disorder (an injury or a disease) of the patient.

Recently, in order to improve work efficiency in the medical field, computerization of medical images and charts has been promoted. Under this trend, systems for making the above-mentioned image interpretation online have been suggested for example in JPA2007-041684.

To display an image interpretation report, an appropriate inspection request is selected from among those listed up on a display screen. If the inspection requests are uniformly displayed on the list, the doctor cannot distinguish such a report that diagnoses necessity of an urgent treatment or that describes an important content, which can result in a delay of treatment or an improper treatment.

To solve this problem, the report making system of the above-mentioned prior art suggests setting the degree of importance to the individual image interpretation report and highlighting those reports with higher degree of importance on the list. As being highlighted, the image interpretation reports with higher degree of importance are easy to distinguish, which is effective to prevent the delay of treatment or improper treatment.

However, doctors who requested the inspections, hereinafter called simply the requesting doctors, do not always check the inspection request list, because they have many other jobs like outpatients' examinations, ward rounds, conferences etc. Therefore, even while an image interpretation report that is requiring an urgent treatment is highlighted, if the requesting doctor is too busy to check the report, it is impossible to prevent the delay of treatment without failure.

As a countermeasure to prevent the delay of treatment, the doctor who makes the image interpretation, hereinafter called simply the interpreting doctor, can notify the requesting doctor of the necessity of urgent treatment. However, since the interpreting doctors have to interpret the medical images at a high speed, sometimes more than 100 pieces per hour, the direct contact to the requesting doctor will lower the work efficiency of the interpreting doctor.

### SUMMARY OF THE INVENTION

In view of the foregoing, a primary object of the present invention is to make sure to prevent the delay of treatment in a case where an urgent countermeasure is necessary, without bothering the interpreting doctors.

To achieve the above and other object, a medical report making system of the present invention comprises a report making device for making a medical report that shows a result of a medical inspection done on a patient according to an inspection request from a requester, an importance setting device for setting a degree of importance of the result of the medical inspection in the medical report, a judging device for judging based on the degree of importance set in the medical report whether an urgent countermeasure is necessary for the patient or not; and a message sender for sending a message to a destination when the judging device judges that an urgent countermeasure is necessary, notifying the necessity of the urgent countermeasure.

Preferably, the message sender makes a judgment as to whether the requester for the medical inspection, of which the result shows that the urgent countermeasure is necessary, is able to check the message at present, and when the requester is able to check the message, the message sender sends the message to the requester, whereas when the requester is not able to check the message at present, the message sender sends the message to a medical worker who is associated with the requester and is able to check the message at present.

Preferably, the medical report making system further comprises a device for managing schedule data that shows respective schedules of medical workers including the requester who belong to a medical facility, wherein the message sender refers to the schedule data to check the schedules of the requester and those medical workers who are associated with the requester, and judges by the schedules whether the requester or any of the associated medical workers are able to check the message.

Preferably, the medical report making system further comprises a device for managing appointment information that shows appointments of medical works to be done in a medical facility, wherein the message sender refers to the appointment information to check what medical works the requester and those medical workers associated with the requester are doing at present, and judges by the medical works whether the requester or any of the associated medical workers are able to check the message.

Preferably, the medical report making system further comprises a device for detecting respective locations of medical workers who belong to a medical facility, including the requester, wherein the message sender judges whether the requester or any of those medical workers who are associated with the requester are able to check the message, on the basis of the respective locations of the requester and the associated medical workers.

According to another preferred embodiment, the message sender assigns the requester for the medical inspection, of which the result shows that the urgent countermeasure is necessary, and also those medial workers who participate in the treatment of the inspected patient to be the destination of the message.

According to another preferred embodiment, the medical report making system further comprises nurse station terminals installed in respective nurse stations of a medical facility, and a device for managing ward information on respective wards, which medical workers including the requester are assigned to in the medical facility, wherein the message sender determines the ward the requester is assigned to on the basis of the ward information, and sends the message to a nurse station terminal that is installed in the nurse station of the identified ward.

Preferably, the medical report making system further comprises a list generator for generating a list of inspection requests, and a list display device for displaying the list in the form of a table, the list display device highlighting such inspection requests that the degree of importance of the result of the medical inspection is set to a high level in the medical report.

More preferably, the message sender sends the message to the destination repeatedly till it receives a notice of opening the message from the destination or it confirms that the medical report was referred to.

A medical report making apparatus of the present invention comprises a report making device for making a medical report that shows a result of a medical inspection done on a patient according to an inspection request from a requester; an importance setting device for setting a degree of importance of the result of the medical inspection in the medical report; a judging device for judging based on the degree of importance set in the medical report whether an urgent countermeasure is necessary for the patient or not; and a message sender for sending a message to a destination when the judging device judges that an urgent countermeasure is necessary, notifying the necessity of the urgent countermeasure.

A medical report making method of the present invention comprises steps of:

making a medical report that shows a result of a medical inspection done on a patient according to an inspection request from a requester;

setting a degree of importance of the result of the medical inspection in the medical report;

judging based on the degree of importance set in the medical report whether an urgent countermeasure is necessary for the patient or not; and

sending a message to a destination when the judging device judges that an urgent countermeasure is necessary, notifying the necessity of the urgent countermeasure.

According to the present invention, the judgment as to whether an urgent countermeasure is necessary for the patient or not is made on the basis of the degree of importance set in the medical report, and the message notifying the necessity of urgent countermeasure is sent to the destination if it is judged to be necessary. The message will prompt the requester or the medical worker associated with the requester to refer to the medical report as soon as possible, and thus makes sure to prevent the delay of treatment of the patient in case where the urgent countermeasure is necessary. Moreover, the message is automatically sent out without bothering the person who is in charge of making the medical report.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is an explanatory diagram schematically illustrating a medical network system;

FIG. 2 is a block diagram schematically illustrating a structure of a diagnosis and treatment department terminal;

FIG. 3 is a block diagram schematically illustrating a structure of an image interpretation report making terminal;

FIG. 4 is an explanatory diagram illustrating an example of an inspection request list;

FIG. 5 is an explanatory diagram illustrating an example of a report creation screen;

FIG. 6 is an explanatory diagram schematically illustrating a structure of an image interpretation report;

FIG. 7 is an explanatory diagram schematically illustrating a structure of an inspection request management database;

FIG. 8 is an explanatory diagram schematically illustrating a concept of a massage sending process;

FIG. 9 is an explanatory diagram schematically illustrating a structure of a mail address management table;

FIG. 10 is a flowchart illustrating a sequence of procedures for image-interpretation;

FIG. 11A is an explanatory diagram illustrating an example of an inspection request list that shows merely such an inspection request that a high degree of importance is set in the report;

FIG. 11B is an explanatory diagram illustrating another example of an inspection request list that shows inspection requests while highlighting those given a high degree of importance;

FIG. 12 is an explanatory diagram schematically illustrating a medical network system that is provided with an operation appointment information management database;

FIG. 13 is a flowchart illustrating a procedure of making a judgment as to whether a requesting doctor can check a message on the basis of operation appointment information;

FIG. 14 is an explanatory diagram schematically illustrating a medical network system that is provided with an RFID tag reader;

FIG. 15 is a flowchart illustrating a procedure of making a judgment as to whether a requesting doctor can check a message by the location of the requesting doctor;

FIG. 16 is an explanatory diagram schematically illustrating a medical network system, wherein a message is sent to a nurse station;

FIG. 17 is an explanatory diagram schematically illustrating a structure of a ward information management database; and

FIG. 18 is a flowchart illustrating a procedure of sending the message to the nurse station.

### DESCRIPTION OF THE PREFERRED EMBODIMENTS

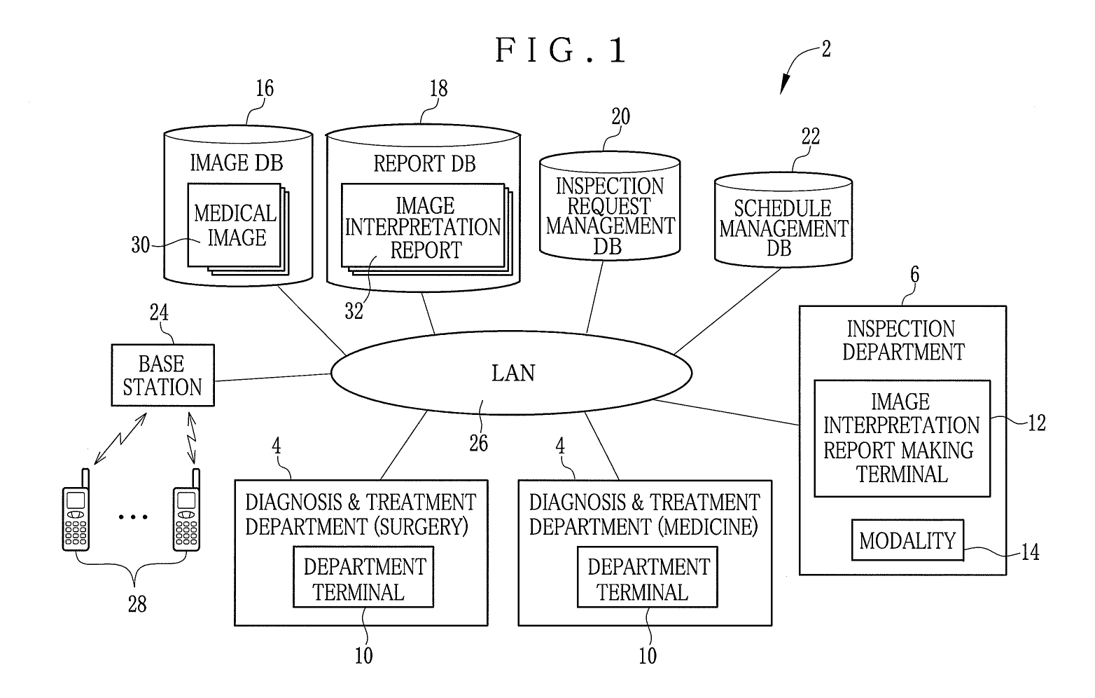

FIG. 1 illustrates a structure of a medical network system that is a medical report making system built up in a medical facility such as a hospital. A medical network system 2 consists of a diagnosis-and-treatment department terminal 10, an image interpretation report making terminal (medical report generator) 12, a modality 14, an image database (DB) 16, a report database 18, an inspection request management database (list generator) 20, a schedule management database (schedule managing device) 22, a base station 24, a Local Area Network (LAN) 26 interconnecting all of these and plural PHS terminals 28, which doctors who belong to the medical facility respectively carry with. The diagnosis-and-treatment department terminal 10, hereinafter called simply as the department terminal, is arranged at each diagnosis-and-treatment department 4 including of surgery and internal medicine. The image interpretation report making terminal 12 is placed at an inspection department 6 such as of radiology. The respective databases 16, 18, 20 and 22 can be built either in the same server or in a respectively independent server.

The modality 14 is a known medical inspection system like, for example, a CR device, a CT scanner and a MRI machine. The modality 14 is installed in the inspection department 6 and obtains medical images 30 like radiographs according to an inspection request from the respective diagnosis-and-treatment departments 4. The image database 16 stores the medical image 30 the modality 14 received and, according to a demand, transfers the stored medical images 30 to the respective department terminals 10 or the image interpretation report making terminal 12.

A doctor who belongs to the each diagnosis-and-treatment department 4 requests an inspection to the inspection department 6 as need arises during diagnosing a patient. The inspection department 6 takes the medical images 30 of the patient according to the inspection request from the each diagnosis-and-treatment department 4 and interprets the medical images 30. A doctor at the inspection department 6, hereinafter referred to as an image interpreting doctor, interprets the medical image 30 and puts the result into an image interpretation report 32 to report the doctor who requested the inspection, hereinafter referred to as a requesting doctor. The requesting doctor makes a final diagnosis based on the image interpretation report 32 from the inspection department 6 and confirms the diagnosis. The medical network system 2 connects the respective department terminals 10 and the image interpretation report making terminal 12 via the LAN 26 to enable the inspection request and the image interpretation reports to be transmitted online. Thus, the medical network system streamlines the operation of the medical facility.

The report database 18 transfers the stored image interpretation report 32 to the department terminal 10 according a demand from the department terminal 10, while storing the image interpretation report 32 generated as electronic data by the image interpretation report making terminal 12.

The inspection request management database 20 manages the whole information on the inspection requests to the inspection department 6. The requesting doctor at the diagnosis-and-treatment department 4 accesses the inspection request management database 20 and registers a new inspection request, to request the inspection department 6 for an inspection. An image interpreting doctor at the inspection department 6 carries out the inspection and image interpretation while accessing to the inspection request management database 20 to check the condition of inspection requests.

The schedule management database 22 manages the whole schedule data indicating individual schedules of all doctors who belong to the medical facility. The schedule data consists of date information showing, for example, from what time to what time on what day, and content information about work contents on each date, forming a time schedule that shows the each doctor's agenda of a day. Every time their schedules of every date are fixed, the respective doctors access the schedule management database 22 and input the new schedule to update their own schedule data. The content information includes outpatients' clinic, in-patients' clinic or ward round, conferences, operations, business trips, holidays etc. Those who update the schedule data are not limited to the doctors. For example, nurses and the like can update it.

The base station 24 makes a wireless communication with the respective PHS terminals 28 and establishes a communication line between the LAN 26 or a public switched telephone network and the PHS terminal 28. The PHS terminal 28 is a so-called in-hospital PHS and has such functions as of communicating with telephone terminals inside and outside the medical facility and sending and receiving e-mails. Although FIG. 1 shows only one base station 24, it is possible to arrange plural base stations 24 in the medical network system 2, for example, every room or floor in the medical facility according to the condition for the wireless communication with the respective PHS terminals 28.

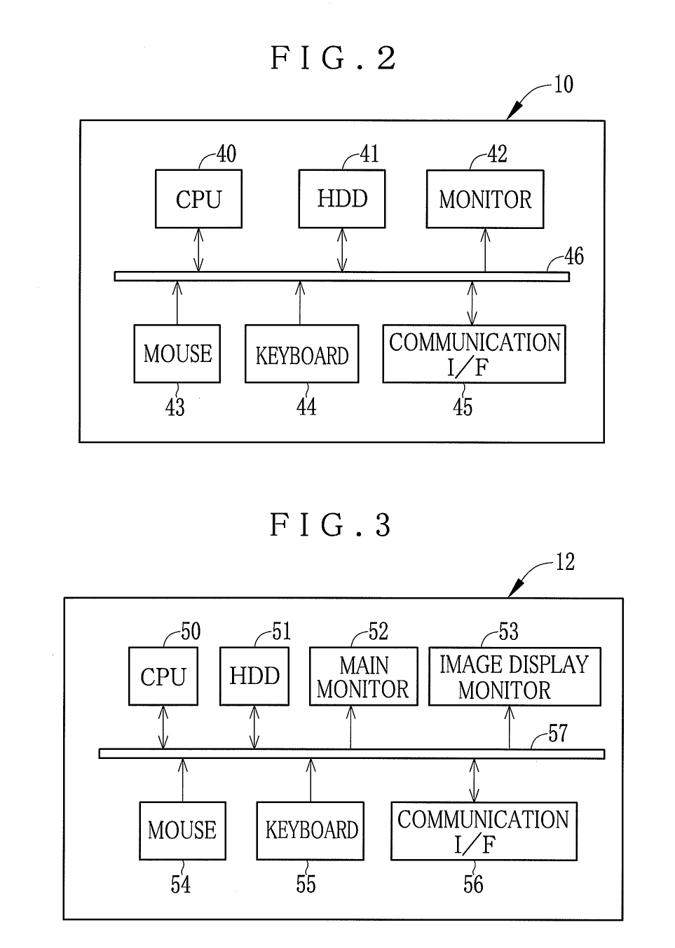

FIG. 2 is a block diagram schematically illustrating the structure of the department terminal 10. The department terminal 10 is represented by a known personal computer and work station and is provided with a CPU 40 controlling the overall operation of every part of the department terminal 10, a HDD 41 storing various programs related to the medical network system 2, a monitor 42 to display the medical image 30 and the image interpretation report 32, a known input device such as a mouse 43 and a keyboard 44 and a communication interface (I/F) 45 to connect the department terminal 10 with the LAN 26. Every part is interconnected through a bus 46. The CPU 40 controls the department terminal 10 by reading out the various programs stored in the HDD 41 and processing one read program after another.

FIG. 3 illustrates the structure of the image interpretation report making terminal 12. The image interpretation report making terminal 12 is represented by the known personal computer and work station and is provided with a CPU 50 controlling the overall operation of every part of the image interpretation report making terminal 12, a HDD 51 storing various programs related to the medical network system 2, a main monitor 52 to display various operation screens, an image display monitor 53 to display the medical image 30, the known input device such as a mouse 54 and a keyboard 55 and a communication interface (I/F) 56 to connect the image interpretation report making terminal 12 with the LAN 26. Every part is interconnected through a bus 57. The CPU 50 controls the image interpretation report making terminal 12 by reading out the various programs stored in the HDD 51 and processing one read program after another.

The image interpretation report making terminal 12 is a dual-monitor setup with two monitors 52 and 53. For the image display monitor 53, a high-definition monitor is used so that the medical images 30 are displayed sharply. The image interpreting doctor makes the interpretation while displaying the medical images 30 on the image display monitor 53, and generates the image interpretation report 32 through a screen displayed on the main monitor 52. Preparing two monitors 52 and 53 and carrying out the Image interpretation and generation of the image interpretation report 32 on respective different screens promote to streamline the procedure of image interpretation at the inspection department 6. In addition, the number of the monitor is not limited to two, but one or more than three are possible.

The inspection request from the respective diagnosis-and-treatment departments 4 to the inspection department 6 is carried out by generating inspection request information at the department terminal 10 and registering it in the inspection request management database 20. When receiving the inspection request information sent from the department terminal 10, the inspection request management database 20 stores the inspection request information, for example, lining it up in the order of the received date. These processes request the inspection to the inspection department 6.

The inspection request information consists of patient information, inspection information and doctor information etc. The patient information is personal information about the patient whose inspection is to be requested and includes, for example, the patient's name, ID, sex, birth date and previous disease. The inspection information is about the content of the requested inspection, including for example inspection items and inspection methods. The inspection items are represented by the kind of the modality 14 and imaged part. The inspection method is about the patient's direction to the modality such as front or side and with or without a contrast agent. The doctor information is about the requesting doctor and includes the requesting doctor's name, ID and department to which they belong, for example. However, the information included in the inspection request information isn't limited to these information.

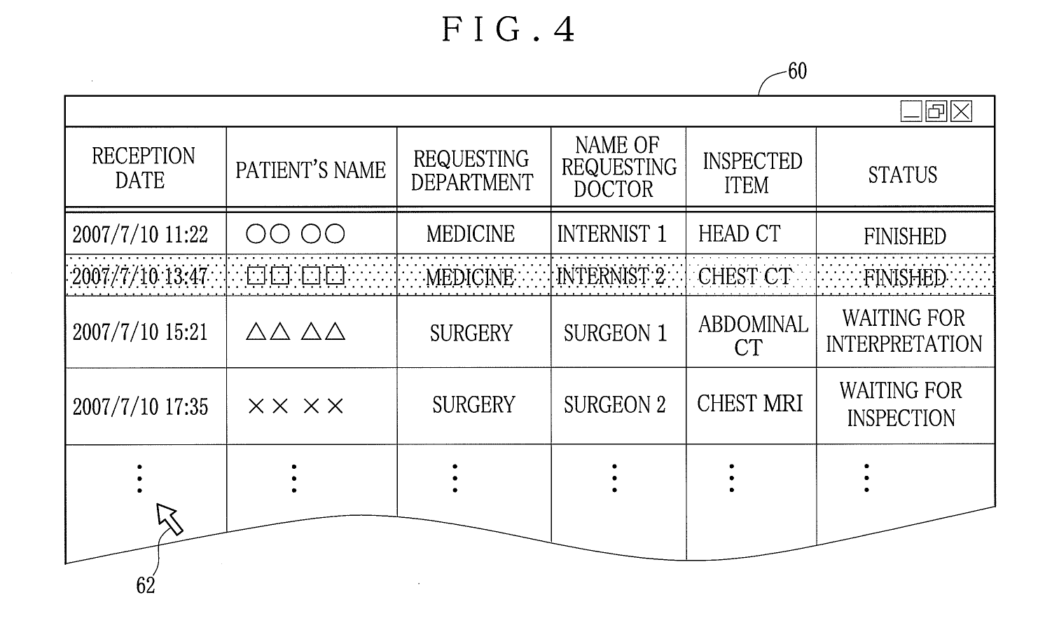

FIG. 4 illustrates an example of an inspection request list 60 displayed on the monitor 42 in the department terminal 10 and the main monitor 52 in the image interpretation report making terminal 12. The inspection request list 60 shows all inspections requested to the inspection department 6 in the form of a table. A pointer 62 is displayed on the inspection request list 60 and moves on the screen in conjunction with the operation of the mice 43 and 54.

The inspection request list 60 has fields to display, for example, the date when the inspection request is received, patient's name, request department, requesting doctor's name, inspection item and status of the inspection request. In the field of the status, for example, “Waiting for inspection” is displayed when neither the inspection nor the Image interpretation has been done. When the inspection has been finished but the Image interpretation has not been completed, “Waiting for Image interpretation” is displayed. When both the inspection and Image interpretation have been completed, “End” is displayed.

In response to a command for displaying the inspection request list 60, which is input through the mouse 43 or 54, the CPU 40 of the department terminal 10 or the CPU 50 of the image interpretation report making terminal 12 requests the inspection request management database 20 to transfer the inspection request list 60. In response to the demand for transferring the inspection request list 60, the inspection request management database 20 puts all stored inspection request information into the inspection request list 60 and forwards it to the waiting terminal 10 or 12. Upon receipt of the inspection request list 60 from the inspection request management database 20, the CPU 40 or 50 display the inspection request list 60 on the monitor 42 or 52.

Doctors who belong to the respective diagnosis-and-treatment departments 4 confirm the statuses of the requested inspections or register a new inspection request through the inspection request list 60. The respective image interpreting doctors who belong to the inspection department 6 check the inspection requests from the respective diagnosis-and-treatment departments 4 through the inspection request list 60 and carry out their various works, such as, taking and interpreting the medical images 30 and generating the image interpretation report 32.

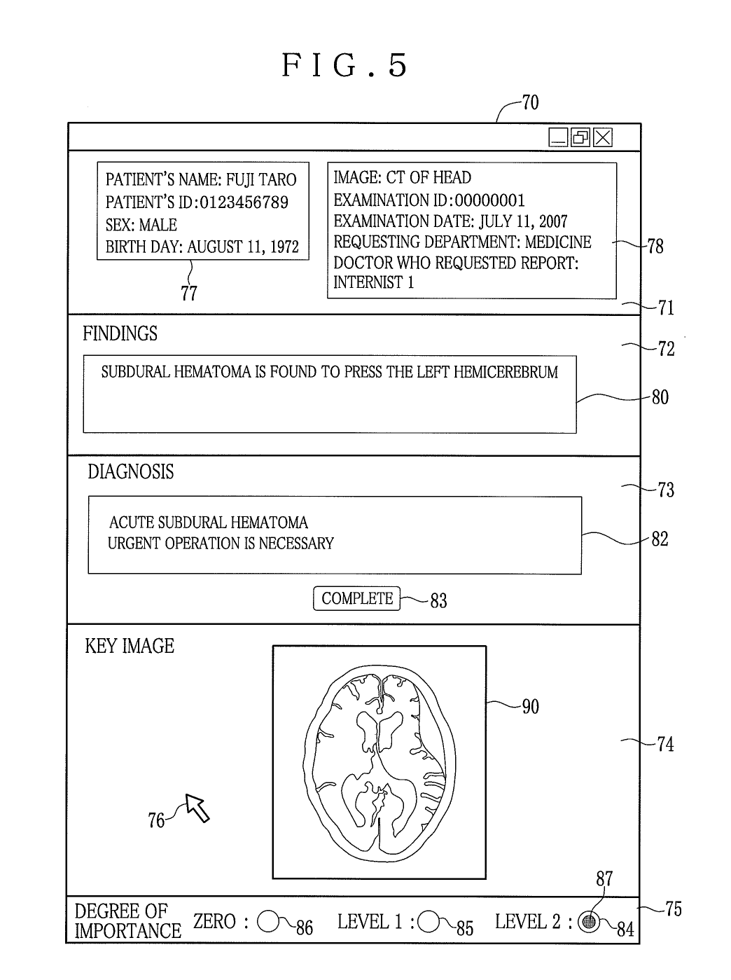

FIG. 5 illustrates an example of a report creation screen 70 displayed on the main monitor 52 in the image interpretation report making terminal 12. The report creation screen 70 is displayed on the main monitor 52 by, for example, selecting an appropriate inspection request from the inspection request list 60. The report creation screen 70 is provided with an information display area 71 to disclose various information, a finding input area 72 to input the doctor's findings, a diagnosis input area 73 to input the doctor's diagnoses, a key image paste area 74 to paste a key image 90, and an importance setting area 75 to set the degree of importance of the image interpretation report 32. A pointer 76 is displayed on the report creation screen 70 and moves on the screen in conjunction with the operation of the mouse 54.

The information display area 71 is provided with a patient information display box 77 and an inspection information display box 78. The information about the patient and inspection relating to the selected inspection request is respectively displayed in the boxes 77 and 78. The finding input area 72 is provided with a text input box 80. The image interpreting doctor interprets the medical images 30 displayed on the image display monitor 53 and inputs their findings into the text input box 80 by use of the keyboard 55.

The diagnosis input area 73 is provided with a text input box 82 and a complete button 83. Like the findings, the image interpreting doctor interprets the medical images 30 and writes a diagnosis into the text input box 82 by the keyboard 55. The complete button 83 is for indicating the completion of generating the image interpretation report 32. The image interpreting doctor makes the image interpretation report 32 by inputting the findings and diagnoses, and completes the image interpretation report 32 by clicking the mouse 54 on the complete button 83. In response to the click on the complete button 83, the CPU 50 of the image interpretation report making terminal 12 stores the generated image interpretation report 32 in the report database 18.

In the key image paste area 74, the medical image 30, which drew the doctor's attention during the image interpretation, is pasted as the key image 90. The key image 90 is made by executing an image processing such as scaling up and down and changing gradation to the medical image 30. The medical image 30 displayed on the image display monitor 53 is also, for example, drug-and-dropped in the key image paste area 74 to be pasted in the key image paste area 74 as the key image 90.

The importance of the image interpretation report 32, which means the degree of importance of the image interpretation's result, is set by two stages: level 1 indicates that there is no urgency but the necessity of some special treatments, and level 2 indicates that an urgent treatment to the patient is required. The importance setting area 75 is provided with a check box 84 to set the importance to the level 2, a check box 85 to set the importance to the level 1 and a check box 86 to set the importance to zero. The importance is set by clicking one of the check boxes 84, 85 and 86. Clicking one of the check boxes 84, 85 and 86 makes a mark 87 displayed in the clicked box, indicating that the importance of the interpretation results is set to the level of the clicked box.

For example, when the doctor diagnoses that the patient has a life-threatening symptom, such like they promptly need surgery or hospital admission, or that the patient needs some treatment during being in the hospital, the image interpreting doctor sets the importance to the level 2. The image interpreting doctor also sets the importance to the level 2 when they cannot make a definitive diagnosis only from the image interpretation of the medical image 30, and wants to confirm by the other inspection. When finding no special abnormality in the medical image 30, the image interpreting doctor sets to no importance. The setting of the importance isn't limited to two stages. One stage or more than two stages are also possible.

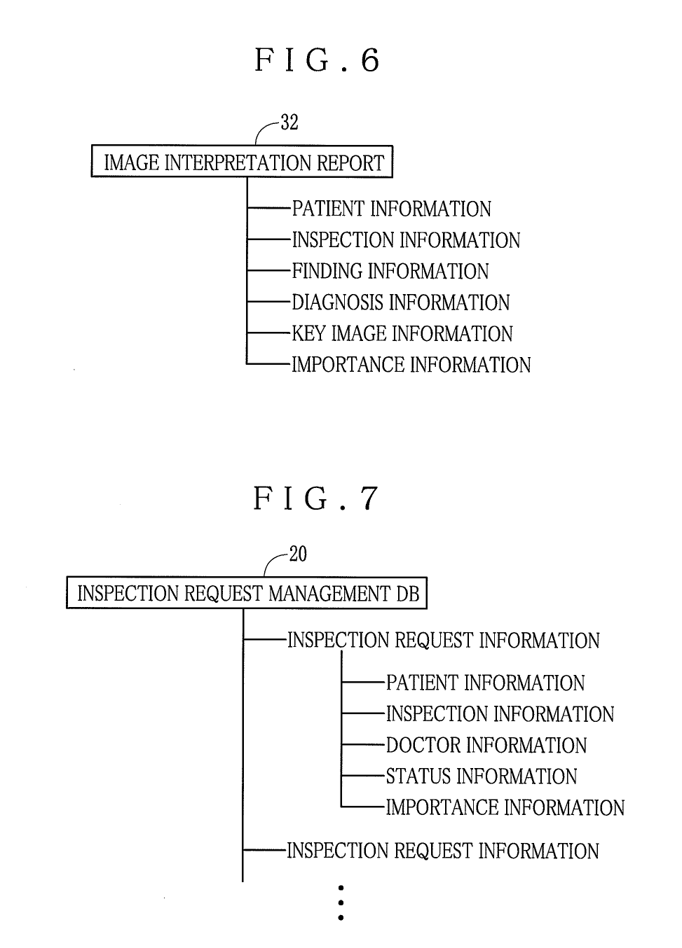

FIG. 6 schematically illustrates the structure of the image interpretation report 32 generated through the report creation screen 70. In the structure of the image interpretation report 32, for example, the patient information displayed in the patient information display box 77, the inspection information displayed in the inspection information display box 78, the finding information displaying the text of findings written in the text input box 80, the diagnosis information displaying the text of diagnoses written in the text input box 82, key image information displaying the key image 90 pasted in the key image paste area 74 and importance information displaying the importance set in the importance setting area 75 are recorded. The key image information can display either the key image 90 itself or an address where the key image 90 is stored. In addition, the information recorded in the image interpretation report 32 isn't limited to the above-mentioned one.

FIG. 7 schematically illustrates the structure of the respective inspection request information stored in the inspection request management database 20. The inspection request information includes status information indicating the status of the inspection request and importance information displaying the importance set in the image interpretation report 32 of the inspection request as well as the above-described patient information, inspection information and doctor information.

The status information for the inspection request has three status; one where neither the inspection nor the image interpretation has been yet done, one where only the image interpretation has not been done yet and one where both the inspection and image interpretation have been already completed. The status item in the inspection request list 60 is displayed based on the status information. The status of the status information and one displayed in the inspection request list 60 are, however, not limited to the above-mentioned three.

When the requesting doctor registers a new inspection request, the status information is set in an initial condition indicating that the inspection and image interpretation have not been done yet, and the importance information is set in an initial condition indicating no importance. When receiving the medical image 30 according to the inspection request, the modality 14 stores the medical images 30 in the image database 16 and sends the inspection request management database 20 a notice informing that the inspection was completed. After receiving the notice about the completion of the inspection from the modality 14, the inspection request management database 20 updates the status information of the inspection request based on the received notice, from the initial condition indicating that the inspection and image interpretation have not yet been done to the next condition indicating that the inspection has been done and the image interpretation has not yet been done.

When the image interpretation report 32 is generated, the CPU 50 in the image interpretation report making terminal 12 stores the image interpretation report 32 in the report database 18 and sends the inspection request management database 20 the notice informing that the generation of the image interpretation report 32 was completed. After receiving the notice about the completion of the report generation from the CPU 50, the inspection request management database 20 updates the status information of the inspection request based on the received notice, from the condition indicating that only the image interpretation has not yet been done to the one indicating that both the inspection and image interpretation have been completed. The CPU 50 sends the importance information of the image interpretation report 32 as well as the notice about the completion of the report generation to the inspection request management database 20. After receiving the importance information from the CPU 50, the inspection request management database 20 renews the importance information in the inspection request information to the received importance information. In this way, the status and set importance of the inspection request are reflected in the respective inspection request information in the inspection request management database 20.

The status information included in the inspection request information is used to display the status item in the inspection request list 60, as previously described. On the other hand, the importance information included in the inspection request information is used to emphatically show the respective inspection requests displayed in the inspection request list 60. The respective CPUs 40 and 50 of the department terminal 10 and image interpretation report making terminal 12 check the importance information included in the respective inspection request information, when displaying the inspection request list 60 on the monitors 42 and 52. When either the level 1 or 2 of the importance is set, the CPUs 40 and 50 emphatically display the inspection request, as like the inspection request shown in the second line in the FIG. 4. Highlighting like this allows the requesting doctors or the like to immediately recognize the inspection request which the importance is placed on. For the emphatic display, it is possible either to change a background color or to reverse its characters and background. In addition, it is possible to make a mark indicating the level of importance or the like display respectively in another field.

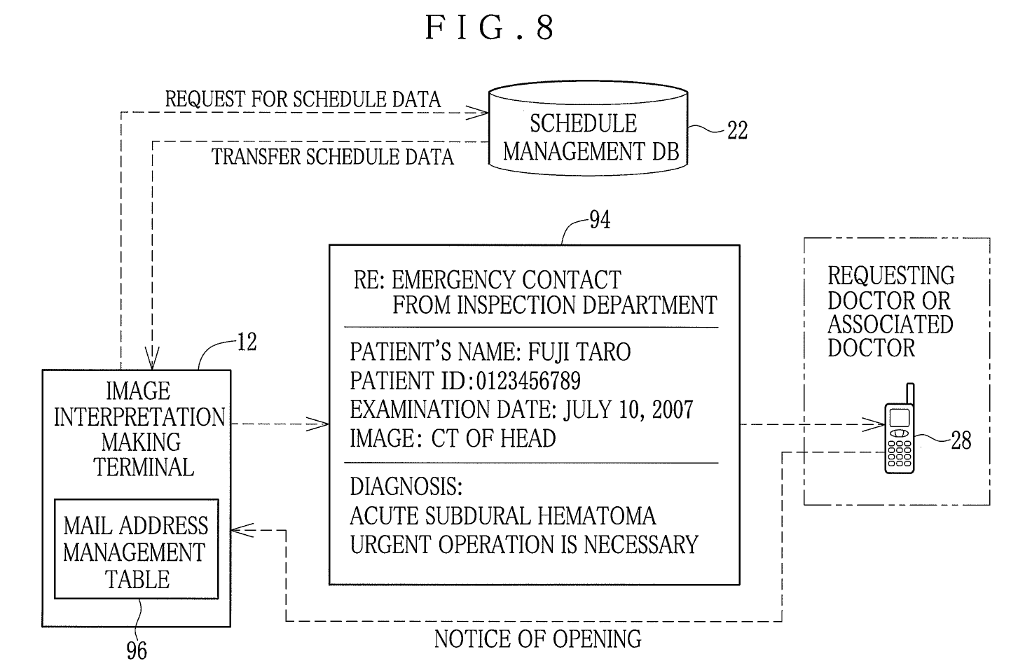

The CPU 50 of the image interpretation report making terminal 12 executes a process of sending a message, as shown in FIG. 8, when the image interpretation report 32 whose importance is set to the level 2 is generated. When the image interpretation report 32 whose importance is set to the level 2 is generated, the CPU 50 accesses the schedule management database 22 and requests to transfer the schedule data of the requesting doctor at present. When receiving the transmission request, the schedule management database 22 confirms the schedule data of the requesting doctor based on, for example, the doctor ID included in the transmission request. After confirming the schedule data of the requesting doctor, the schedule management database 22 extracts only a part corresponding to the current moment and transfers the extracted schedule data to the image interpretation report making terminal 12.

Upon receipt of the schedule data from the schedule management database 22, the CPU 50 confirms the schedule of the requesting doctor based on the schedule data and judges whether the requesting doctor is ready to check the message or not at present. The CPU 50 judges that the requesting doctor is ready to check the message if the schedule of the requesting doctor is, for example, outpatients' clinic, ward rounds or conference at that moment. On the other hand, if the schedule of the requesting doctor is, for example, surgery, business trip or holiday, the CPU 50 judges that the requesting doctor isn't ready to check the message.

If the CPU 50 judges that the requesting doctor is ready to check the message, the CPU 50 makes a message 94 in a format of e-mail. The CPU 50 records, for example, such items as the patient's name and ID, the inspection date and item and diagnosis in a template which a subject is already written to make the message 94. That is to say, the CPU 50 makes the message 94 so that it is clear why which patient needs an urgent treatment in the inspection of when and what purpose. Recording respective items in the template is based on the patient, inspection and diagnosis information included in the image interpretation report 32. The items to be written in the message 94 and the format of the message 94 aren't limited to the above-mentioned ones.

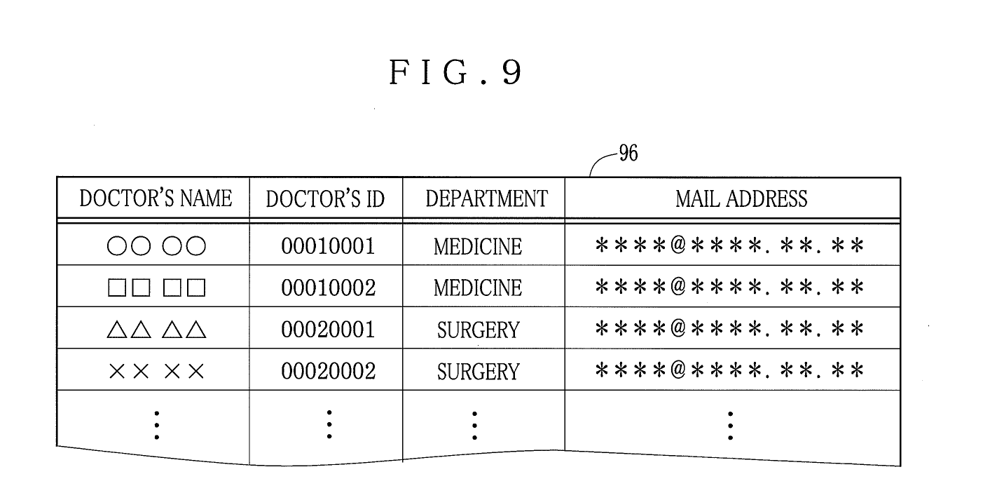

The image interpretation report making terminal 12 is provided with a mail-address management table 96. The mail-address management table 96 is a so-called address note and is connectedly recorded names of all doctors who belong to the medical facility, the doctor IDs, the diagnosis-and-treatment departments 4 where they belong and mail addresses of their PHS terminal 28, as shown in FIG. 9. The mail-address management table 96 is stored in, for example, the HDD 51.

When making the message 94, the CPU 50 refers to the mail-address management table 96 to confirm the requesting doctor's mail address. After confirming the mail address, the CPU 50 sets the mail address to its destination and sends the made message 94 to the requesting doctor's PHS terminal 28. The PHS terminal 28 confirms that the received message 94 was read and sends the notice that the message 94 was opened to the image interpretation report making terminal 12.

On the other hand, when judging that the requesting doctor isn't ready to check the message, the CPU 50 determines a doctor who is associated with the requesting doctor, hereinafter referred to as an associated doctor. For example, the CPU 50 refers to the mail-address management table 96 and determines a doctor to be an associated doctor, who belongs to the same diagnosis-and-treatment department 4 as the requesting doctor. After determining the associated doctor, the CPU 50 requests the schedule management database 22 to transfer the schedule data of the associated doctor and judges whether the associated doctor is ready to check the message or not. The CPU 50 repeats the above-mentioned process until it finds an associated doctor who is ready to check the message. When finally finding the associated doctor who is ready to check the message, the CPU 50 makes the message 94, confirms the mail address and sends the message 94 to the associated doctor's PHS terminal 28, in the same way as the case of the requesting doctor.

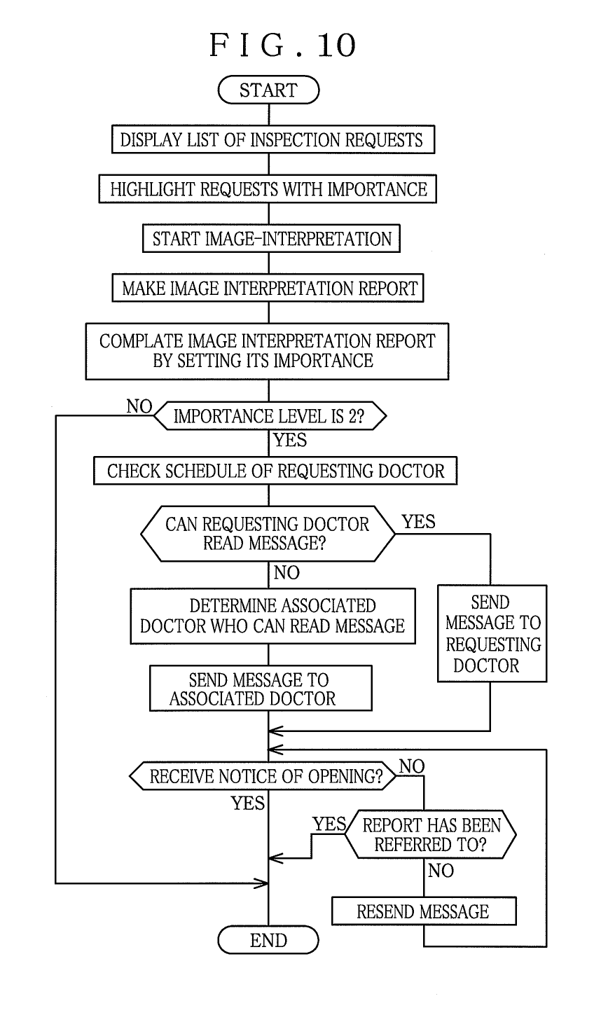

Next, the operation of the medical network system 2 in the above described embodiment will be explained, while referring to a flowchart shown in FIG. 10. On the image interpretation, the image interpreting doctor who belongs to the inspection department 6 makes the inspection request list 60 (See FIG. 4) be displayed on the main monitor 52 in the image interpretation report making terminal 12. When displaying the inspection request list 60, the CPU 50 in the image interpretation report making terminal 12 highlights the inspection request on which the importance is attached, based on the importance information included in the respective inspection request information. This highlighting display makes it easy to distinguish between the inspection request with importance and one without importance.

The image interpreting doctor selects the inspection request which displays “Waiting for Image Interpretation” in the status field out of the inspection request list 60 to start the image interpretation of the medical image 30 and the generation of the image interpretation report 32. When a given inspection request is selected in the inspection request list 60, the medical image 30 corresponding to the inspection request is read out from the image database 16 and is displayed on the image display monitor 53. At the same time, the report creation screen 70 is also displayed on the main monitor 52.

The image interpreting doctor carries out the image interpretation of the medical image 30 through the image display monitor 53. The image interpreting doctor then generates the image interpretation report 32, inputting their findings and diagnosis, pasting the key image 90 and judging the importance. When completing to generate the image interpretation report 32, the image interpreting doctor clicks the complete button 83 to fix the image interpretation report 32.

When the image interpretation report 32 is fixed, the CPU 50 judges whether the importance is set to the level 2 or not. When judging the importance is set to the level 1 or no importance, the CPU 50 stores the generated image interpretation report 32 in the report database 18 and sends the inspection request management database 20 the notice that the generation of the image interpretation report 32 is finished.

On the other hand, when judging the importance is set to the level 2, the CPU 50 carries out the process of sending the message, as previously described. When judging the importance is set to the level 2, the CPU 50 requests the schedule management database 22 to transfer the schedule data of the requesting doctor and checks the requesting doctor's schedule at present. With reference to the requesting doctor's schedule, the CPU 50 judges whether the requesting doctor is ready to check the message at present or not.

When judging that the requesting doctor is ready to check the message, the CPU 50 makes the message 94 and refers to the mail-address management table 96 to confirm the requesting doctor's mail address. The CPU 50 then places the mail address to the destination and sends the generated message 94 to the requesting doctor's PHS terminal 28. In this way, the message 94 is sent to the requesting doctor to inform that the urgent treatment is required, so that the requesting doctor can notice the image interpretation report 32 in shorter time and make the treatment as soon as possible. On this occasion, because the CPU 50 automatically generates the message 94 based on the patient information, the inspection information and the diagnosis information, which are contained in the image interpretation report 32, the image interpreting doctor needs not to waste their time for it.

On the other hand, when judging that the requesting doctor isn't ready to check the message, the CPU 50 starts to determine the associated doctor who is ready to check the message. When the associated doctor is determined, the CPU 50 makes the message 94 and refers the mail-address management table 96 to confirm the associated doctor's mail address. The CPU 50 then places the mail address to the destination and sends the generated message 94 to the associated doctor's PHS terminal 28. In this way, the schedule of the individual doctor who belongs to the medical facility is confirmed, and when the requesting doctor isn't ready to check the message 94, the message 94 is sent to the associated doctor, in order to prevent delay of such treatment that must be done urgently.

The CPU 50 stores the generated image interpretation report 32 in the report database 18 and sends the notice that the generation of the image interpretation report 32 is finished to the inspection request management database 20 and sends the message 94 to the requesting doctor or the associated doctor.

After sending the message 94 to the requesting doctor or the associated doctor, the CPU 50 judges whether it receives the notice of opening the message from the PHS terminal 28. When judging that it doesn't receive the notice of opening the message, the CPU 50 accesses the report database 18 and judges whether the corresponding image interpretation report 32 is referred to by the requesting doctor or the associated doctor or not. If it is judged that the image interpretation report 32 has not yet been referred to, the CPU 50 resends the message 94 to the requesting doctor or the associated doctor. The CPU 50 regularly repeats the process of resending the message 94 until it receives the notice of opening the message, or confirms that the image interpretation report 32 is referred to. Resending the message 94 repeatedly until it is confirmed that the message 94 or the corresponding image interpretation report 32 is referred to by the requester or the associated doctor makes sure to prevent the treatment from being belated.

In the above described embodiment, the image interpreting doctor manually sets the importance by checking one of the check boxes 84, 85 and 86. It is alternatively possible to automatically set the importance by, for example, judging from the text of the findings written in the text input box 80 and the diagnosis in the text input box 82. In the case of setting the importance automatically, it is also possible to store the image interpretation report 32 in the report database 18 and set the importance of the stored image interpretation report 32 in the report database 18, instead of setting the importance in the image interpretation report making terminal 12.

In the above described embodiment, the message 94 is automatically made by the CPU 50. Instead of this, the image interpreting doctor may make the message 94. In the above described embodiment, the message 94 is made based on the information about the patient, inspection and diagnosis as contained in the image interpretation report 32, so as to clarify when and for what purpose the inspection of which patient was carried out, and why the urgent treatment is necessary. However, the message may be the image interpretation report 32 as it is, or the address where the PHS terminal 28 can refer to the image interpretation report 32 may be sent as the message.

In the above described embodiment, the mail-address management table 96 is stored in the HDD 51 of the image interpretation report making terminal 12. However, the mail-address management table 96 may be built as a database in a server that is connected to the LAN 26.

In the above described embodiment, the PHS terminal 28 receives the message 94. The terminal which receives the message 94 is not limited to the PHS, but such a known terminal as mobile phone, PDA and pager is usable as the message receiving terminal. The department terminal 10 can also be the message receiving terminal. Considering the urgency of the message, however, the message receiving terminals are preferably those which the respective medical workers including the requesting doctor can carry with, as those previously described. In the above described embodiment, the message 94 is made in the format of e-mail. However, the format of the message isn't limited to this. It is possible to select the appropriate format according to the receiving terminal such as a short message service or instant message, for example. In addition, it is possible to generate the message in an instrumental voice and play the instrumental voice to a phone.

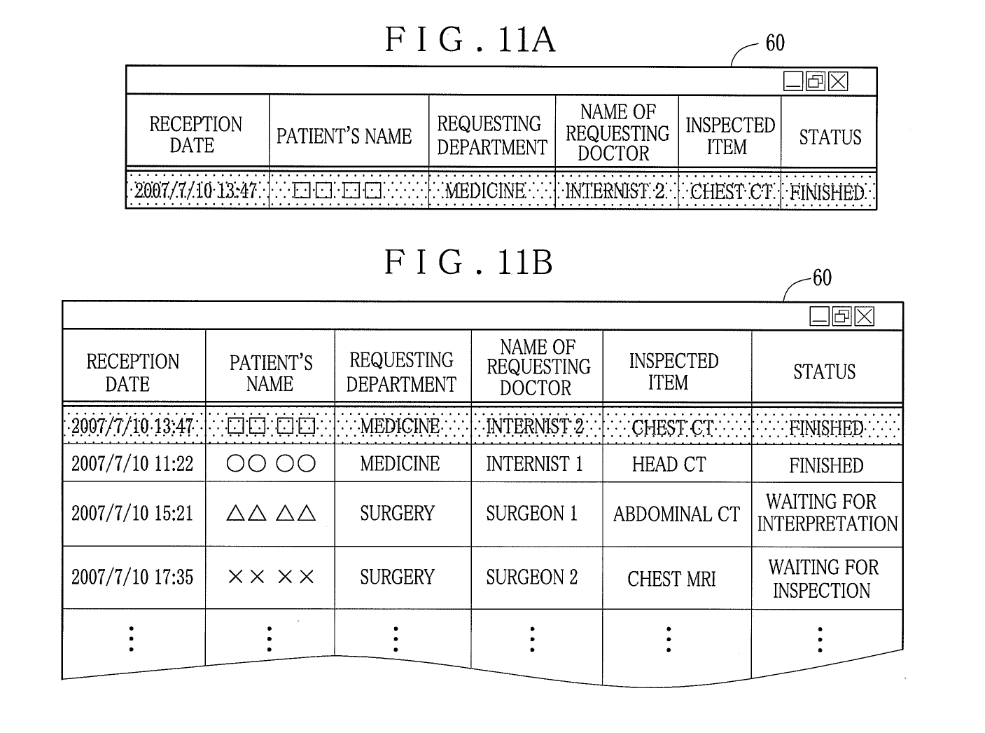

In the above described embodiment, the inspection request on which the importance is attached is highlighted when it is displayed in the inspection request list 60 on the monitors 42 and 52. It is, however, possible to provide the inspection request list 60 with such a filtering function that only the inspection requests on which the importance is attached are listed up. As the way of listing up the inspection requests, only the inspection requests on which the importance is attached can be listed up, as shown in FIG. 11A or the inspection requests on which the importance is attached can be displayed on the top of the list, as shown in FIG. 11B.

In the above described embodiment, the message 94 is sent to either the requesting doctor or the associated doctor. Instead of this, it is possible to send the message 94 to both the requesting doctor and the associated doctor at the same time. For example, when the diagnosis that requires the urgency is given, the requesting doctor (the doctor in charge) sometimes holds a meeting like an urgent briefer with the respective associated doctors who participate in the cure of the inspected patient. For example, when the doctor in charge is an internist, the associated doctors may belong to other departments such as cerebral surgery and surgery. In such a case, setting plural destinations such as the requesting doctor and the associated doctors to send the message 94 promotes holding the meeting smoothly. In this case, instead of sending the message 94 from the image interpretation report making terminal 12 directly to the respective doctors, it is possible to send the message 94 to the department terminal 10 of the diagnosis-and-treatment department 4 the requesting doctor belongs to, and then from this department terminal 10 to the respective doctors.

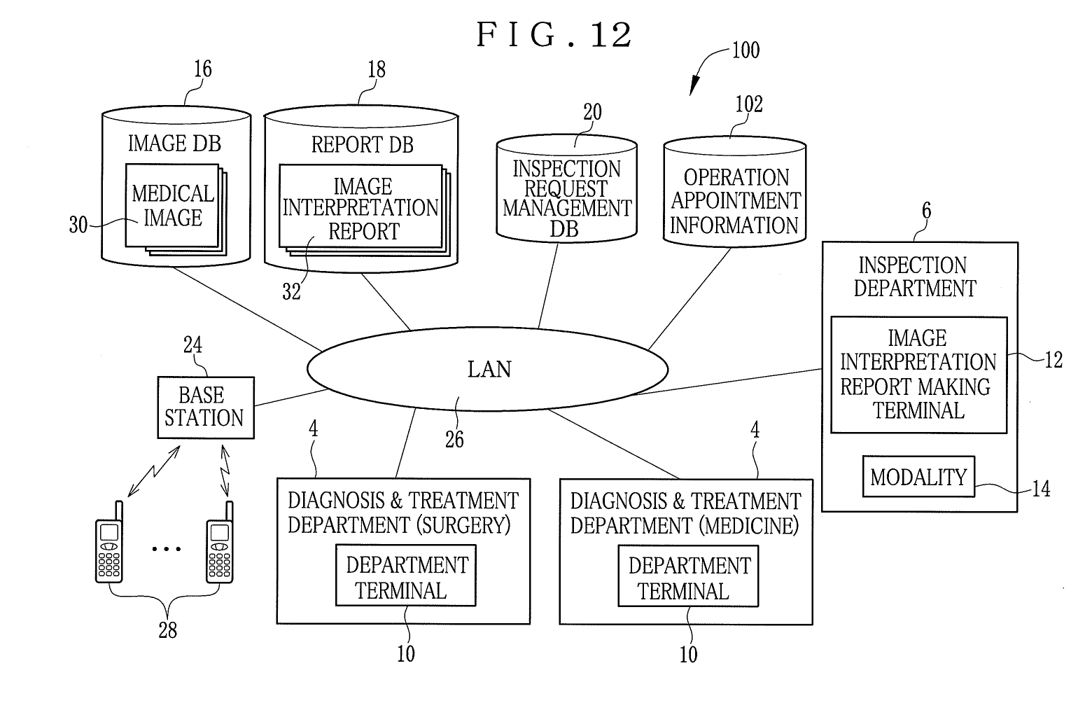

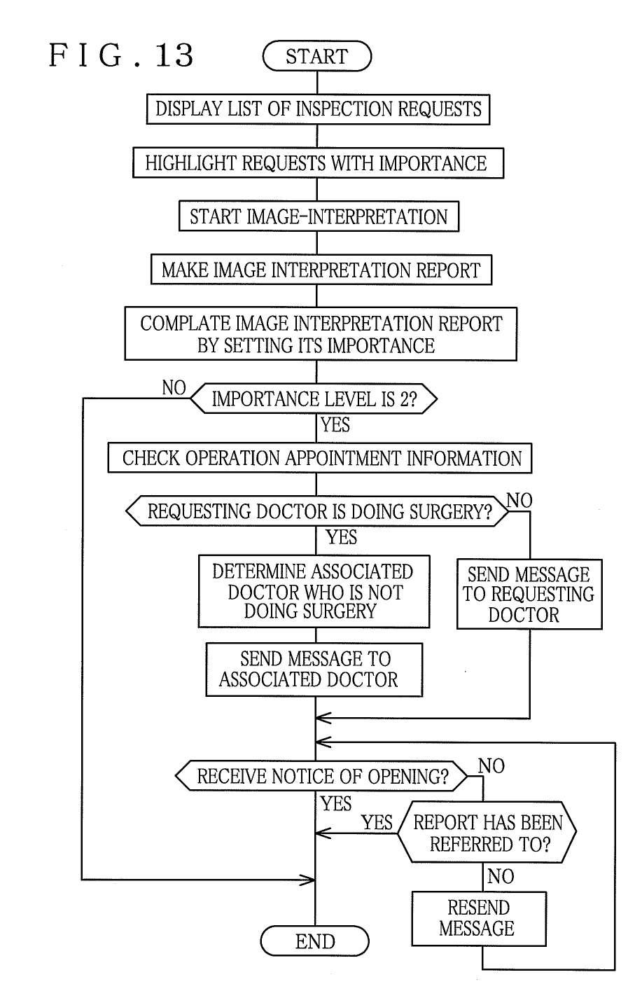

Next, a second embodiment of the present invention will be explained while referring to FIGS. 12 and 13, wherein those elements which are equivalent in the function or construction to those of the above-described first embodiment will be designated by the same reference numerals, so the detailed explanation of these elements will be omitted. As shown in FIG. 12, instead of the schedule management database 22 in the above described first embodiment, a medical network system 100 according to the second embodiment is provided with an operation appointment information management database 102 that is a device of managing operation appointments. The operation appointment information management database 102 manages the whole operation appointment information about the condition of appointments of the operations to be performed in the medical facility. The operation appointment information consists of, for example, the operation's date and room, style, a target patient, and doctors who will carry out the operation, including an operating surgeon, assistants and an anesthesiologist.

According to the above described first embodiment, it is judged whether the requesting doctor is ready to check the message at present by confirming the requesting doctor's schedule based on the schedule data of the respective doctors as stored in the schedule management database 22. As shown in FIG. 13, however, the above-mentioned judgment is made based on the operation appointment information according to the second embodiment.

When an image interpretation report 32 is fixed, a CPU 50 in an image interpretation report making terminal 12 judges whether the importance is set to the level 2 or not. When judging that the importance is set to the level 2, the CPU 50 accesses the operation appointment information management database 102 to refer the operation appointment information. The CPU 50 judges whether a requesting doctor is performing the operation or not at present based on the operation appointment information.

If the CPU 50 determines that the requesting doctor is not doing the surgery now, it judges that the requesting doctor is ready to check the message and then sends a message 94 to the requesting doctor. On the other hand, when judging that the requesting doctor is performing the operation, the CPU 50 judges that the requesting doctor isn't ready to check the message. The CPU 50 then determines an associated doctor who is not performing any operation now with reference to the operation appointment information, and sends the message 94 to the associated doctor.

Judgment as to whether the requesting doctor is ready to check the message or not can be made this way based on the operation appointment information, to obtain the same result as the above described first embodiment. Instead of the operation appointment information, it is also possible to judge whether the requesting doctor is ready to check the message or not based on the other appointment information such as appointments of medical examinations and consultations.

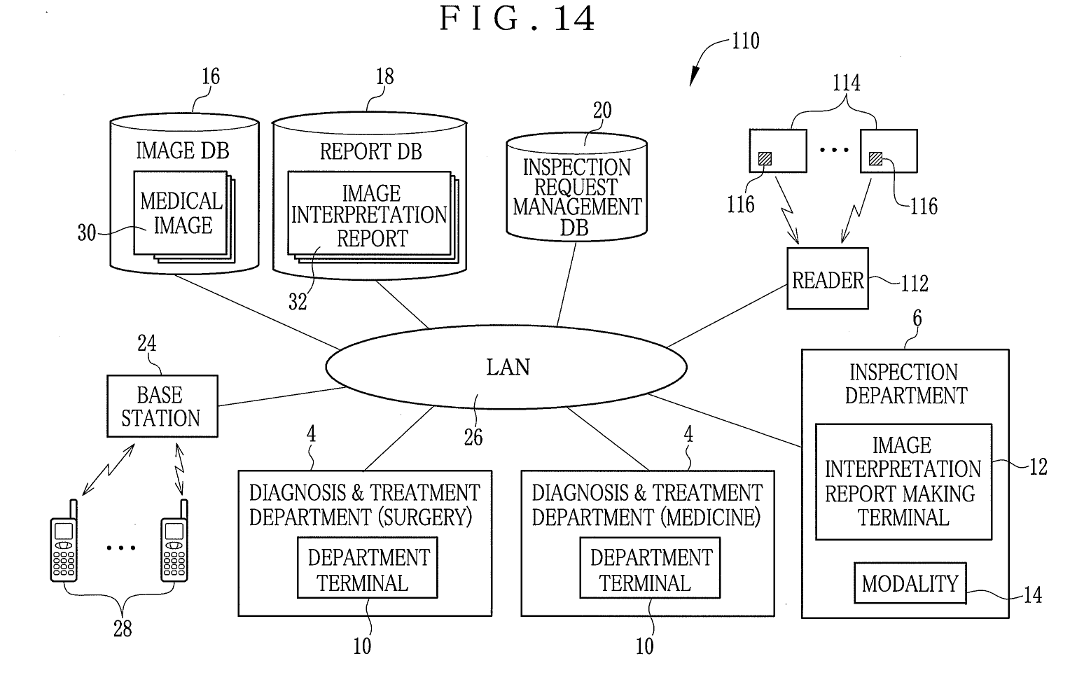

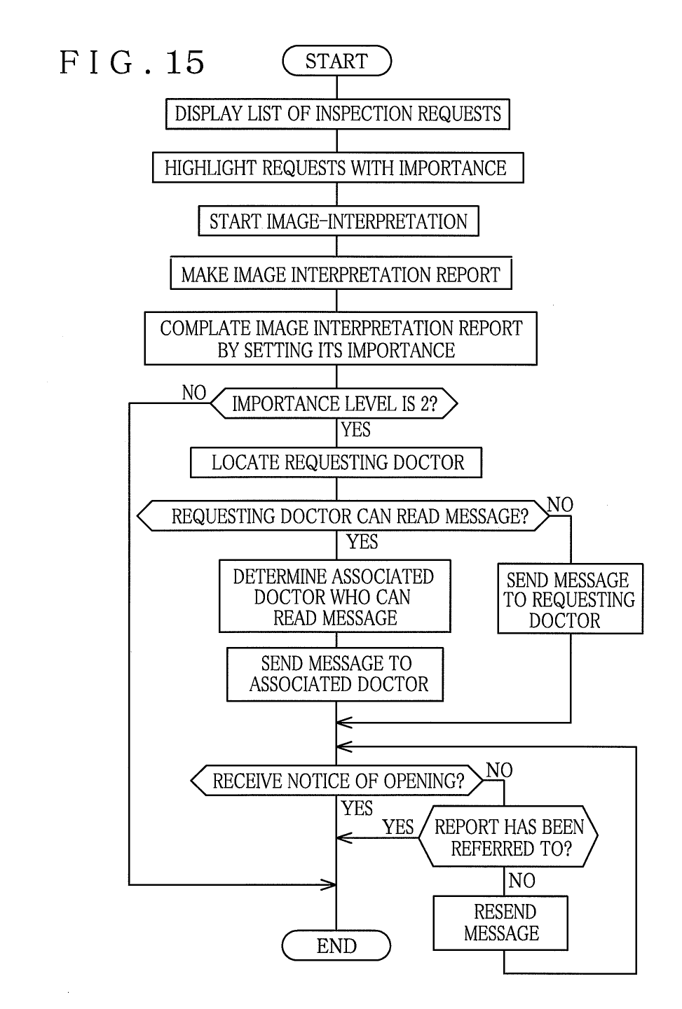

Next, a third embodiment of the present invention will be explained while referring to FIGS. 14 and 15. As shown in FIG. 14, a medical network system 110 according to the third embodiment is provided with a reader 112 that is a device of locating the doctors. The reader 112 wirelessly communicates with RFID (radio frequency identification) tags 116 attached on nameplates 114, which individual doctors in a medical facility wear with them, and reads information stored in the RFID tags 116. In the RFID tag 116, the information identifying a doctor, such as the doctor's name and ID, is recorded. Though it is not shown in the FIG. 14, the medical network system 110 is provided with plural readers 112 according to the environment of communication with the RFID tags 116. By reading the doctor's ID or the like stored in the RFID tag 116 through the respective readers 112, the medical network system 110 can detect every doctor's location in the medical facility.

As shown in FIG. 15, when an image interpretation report 32 is finished, a CPU 50 in an image interpretation report making terminal 12 judges whether the importance is set to the level 2 or not. Judging that the importance is set to the level 2, the CPU 50 accesses the respective readers 112 to confirm a requesting doctor's whereabouts based on the doctor ID or the like. The CPU 50 judges whether the requesting doctor is ready to check a message at present or not based on their confirmed whereabouts.

When the CPU 50 detects that the requesting doctor is located in an examination room or conference room, it judges that the requesting doctor is ready to check the message. And when judging that the requesting doctor is located in an operation room, the CPU 50 judges that the requesting doctor isn't ready to check the message.

When judging that the requesting doctor is ready to check the message, the CPU 50 sends a message 94 to the requesting doctor. On the other hand, when judging that the requesting doctor isn't ready to check the message, the CPU 50 accesses the respective readers 112 to detect associated doctors' locations, and identifies the associated doctor who is ready to check the message. The CPU 50 then sends the message 94 to the associated doctor. This way, whether the requesting doctor is ready to check the message or not may be judged by the respective doctors' locations, to obtain the same result as the above described first and second embodiments.

According to the third embodiment, the RFID tag 116 is attached to the nameplate 114. However, the place where the RFID tag 116 is attached isn't limited to this. Anything is usable insofar as the doctor can carry it about. In the third embodiment, the reader 112 and the RFID tag 116 detect the requesting doctor's whereabouts. Instead of this, however, it is possible to detect the whereabouts by GPS or by using a terminal including PHS 28 and mobile phone.

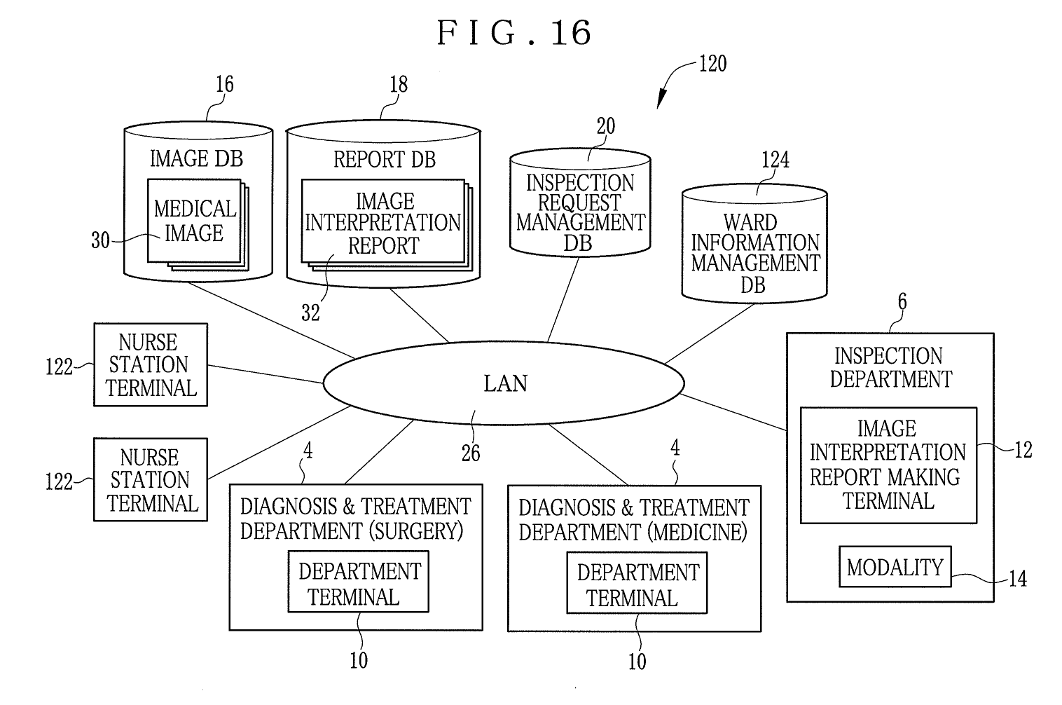

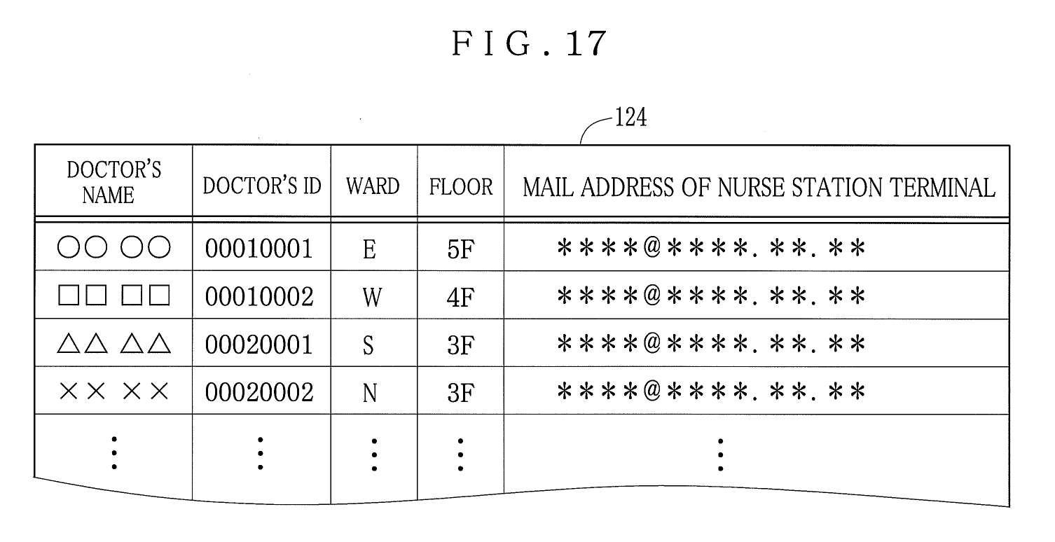

Next, a fourth embodiment of the present invention will be explained while referring to FIGS. 16, 17 and 18. As shown in FIG. 16, a medical network system 120 according to the fourth embodiment is provided with a plurality of nurse station terminals 122 and a ward information management database 124 that is a device of managing ward information. The nurse station terminals 122 are placed at respective nurse stations arranged on respective floors of wards in a medical facility. The nurse station terminal 122 has the same constitution as a department terminal 10.

The ward information management database 124 manages the whole ward information indicating the respective wards which the doctors in the medical facility are assigned to. As shown in 17, the ward information correlates, for example, each doctor's name, ID, assigned ward, floor and a mail address of the nurse station terminal 122 placed at the nurse station on the assigned floor. However, the contents of the ward information are not limited to the above-mentioned ones.

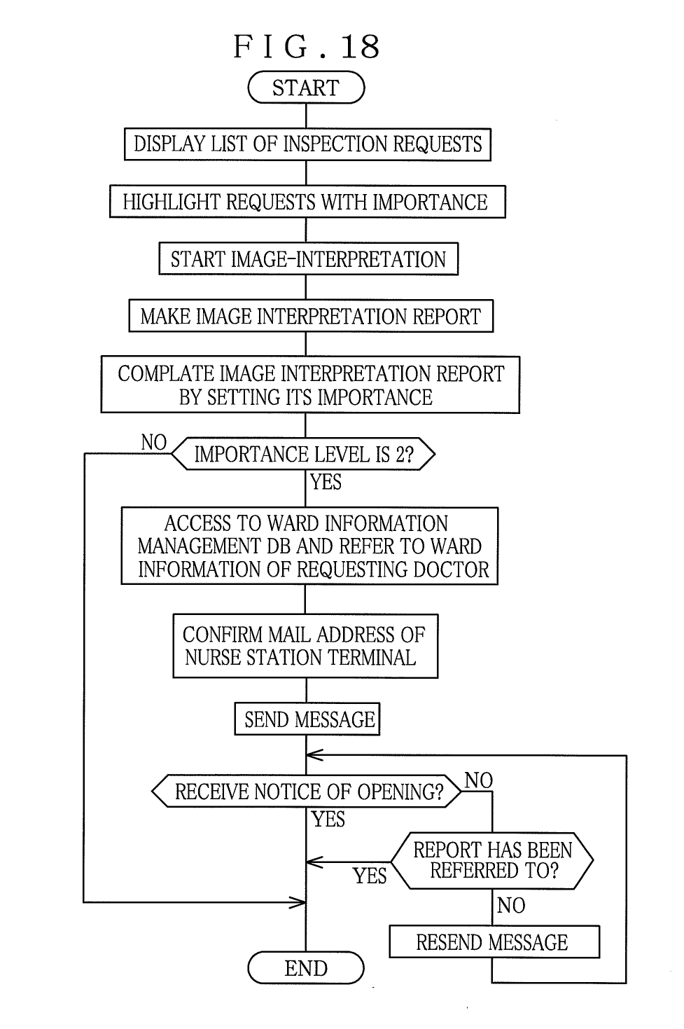

As shown in FIG. 18, when an image interpretation report 32 is fixed, a CPU 50 in an image interpretation report making terminal 12 judges whether the importance is set to the level 2 or not. When judging that the importance is set to the level 2, the CPU 50 accesses the ward information management database 124 to refer to the ward information of a requesting doctor. With reference to the ward information, the CPU 50 confirms the mail address of the nurse station terminal 122 placed at the nurse station on the ward and floor where the requesting doctor is assigned to, and sends a message 94 to the nurse station terminal 122. When the message 94 is checked by a nurse or the like, the nurse station terminal 122 sends a notice of opening the message to the image interpretation report making terminal 12. In the same way as the above described respective embodiments, the CPU 50 regularly repeats a process of resending the message 94 until it receives the notice of opening the message from the nurse station terminal 122, or it confirms that the image interpretation report 32 is referred to.

In the above described respective embodiments, the message 94 is sent directly to the requesting doctor or associated doctor. Instead of this way, as described in the fourth embodiment, it is possible to send the message 94 to the nurse station terminal 122 so that the nurse informs the requesting doctor or associated doctor that an urgent treatment is required.

In the fourth embodiment, the message 94 is sent to the nurse station terminal 122 placed at the nurse station on the floor of the ward where the requesting doctor is assigned to. However, where the requesting doctor and the associated doctors are assigned to different wards or floors, it is possible to judge whether the requesting doctor is ready to check the message or not and then select the nurse station terminal 122 to send the message 94 based on the result of the judgment, like the above described respective embodiments.

In the fourth embodiment, the nurse passes the information to the requesting doctor or the associated doctor. Instead, the message may be passed to the doctor by way of the other medical workers such as medical processors. It is also possible to send the message 94 to multiple destinations at the same time, for example, to a PHS terminal 28 in addition to the nurse station terminal 122. Sending the message 94 to the plural destinations at the same time more firmly prevents a treatment from being belated.

In the above described respective embodiments, the present invention is applied to a system utilized in one medical facility. The present invention is not limited to this application, but applicable to a system build up by connecting plural medical facilities via a network. In the above described respective embodiments, a medical inspection means taking the medical images 30 and a medical report means the image interpretation report 32. However, the present invention is not limited to these definitions. For instance, it is possible to designate a biochemical examination of blood, urine, etc. as the medical inspection, and the present invention is applicable to a system of making a report about the result of these inspections. In addition, the present invention can be embodied as a program.

Thus, the present invention is not to be limited to the above embodiments but, on the contrary, various modifications will be possible without departing from the scope of claims appended hereto.

What is claimed is:

1. A medical report making system comprising:
a report making device for making a medical report that shows a result of a medical inspection done on a patient according to an inspection request from a requester;
an importance setting device for setting a degree of importance of the result of the medical inspection in said medical report;
a judging device for judging based on the degree of importance set in said medical report whether an urgent countermeasure is necessary for the patient or not; and
a message sender for sending a message to a destination when said judging device judges that an urgent countermeasure is necessary, notifying the necessity of the urgent countermeasure.

2. A medical report making system as recited in claim 1, wherein said message sender makes a judgment as to whether the requester for the medical inspection, of which the result shows that the urgent countermeasure is necessary, is able to check said message at present, and when the requester is able to check said message, said message sender sends said message to the requester, whereas when the requester is not able to check said message at present, said message sender sends said message to a medical worker who is associated with the requester and is able to check said message at present.

3. A medical report making system as recited in claim 2, further comprising a device for managing schedule data that shows respective schedules of medical workers including the requester who belong to a medical facility, wherein said message sender refers to said schedule data to check the schedules of the requester and those medical workers who are associated with the requester, and judges by the schedules whether the requester or any of the associated medical workers are able to check said message.

4. A medical report making system as recited in claim 2, further comprising a device for managing appointment information that shows appointments of medical works to be done in a medical facility, wherein said message sender refers to said appointment information to check what medical works the requester and those medical workers associated with the requester are doing at present, and judges by the medical works whether the requester or any of the associated medical workers are able to check said message.

5. A medical report making system as recited in claim 2, further comprising a device for detecting respective locations of medical workers who belong to a medical facility, including the requester, wherein said message sender judges whether the requester or any of those medical workers who are associated with the requester are able to check said message, on the basis of the respective locations of the requester and the associated medical workers.

6. A medical report making system as recited in claim 1, wherein said message sender assigns the requester for the medical inspection, of which the result shows that the urgent countermeasure is necessary, and also those medial workers who participate in the treatment of the inspected patient to be the destination of said message.

7. A medical report making system as recited in claim 1, wherein said message sender sends said message to a portable communication terminal that each individual medical worker including the requester can carry about.

8. A medical report making system as recited in claim 1, further comprising nurse station terminals installed in respective nurse stations of a medical facility, and a device for managing ward information on respective wards, which medical workers including the requester are assigned to in the medical facility, wherein said message sender determines the ward the requester is assigned to on the basis of said ward information, and sends said message to a nurse station terminal that is installed in the nurse station of the identified ward.

9. A medical report making system as recited in claim 1, further comprising a list generator for generating a list of inspection requests, and a list display device for displaying said list in the form of a table, said list display device highlighting such inspection requests that the degree of importance of the result of the medical inspection is set to a high level in said medical report.

10. A medical report making system as recited in claim 9, wherein said list display device has a filtering function for displaying merely those inspection requests which the degree of importance is set to the high level.

11. A medical report making system as recited in claim 1, wherein said message sender sends said message to the destination repeatedly till it receives a notice of opening said message from the destination or it confirms that said medical report was referred to.

12. A medical report making system as recited in claim 1, wherein said message sender produces said message on the basis of contents written in said medical report.

13. A medical report making apparatus comprising:
a report making device for making a medical report that shows a result of a medical inspection done on a patient according to an inspection request from a requester;
an importance setting device for setting a degree of importance of the result of the medical inspection in said medical report;
a judging device for judging based on the degree of importance set in said medical report whether an urgent countermeasure is necessary for the patient or not; and
a message sender for sending a message to a destination when said judging device judges that an urgent countermeasure is necessary, notifying the necessity of the urgent countermeasure.

14. A medical report making method comprising steps of:
making a medical report that shows a result of a medical inspection done on a patient according to an inspection request from a requester;
setting a degree of importance of the result of the medical inspection in said medical report;
judging based on the degree of importance set in said medical report whether an urgent countermeasure is necessary for the patient or not; and
sending a message to a destination when said judging device judges that an urgent countermeasure is necessary, notifying the necessity of the urgent countermeasure.
